(19) United States
(12) Patent Application Publication
(10) Pub. No.: US 2003/0151384 A1
(43) Pub. Date: Aug. 14, 2003

(54) 2-start, 4 pole single-phase motor

(76) Inventor: Richard C. Woodward JR., Fullerton, CA (US)

Correspondence Address: Cleveland R. Williams, Suite 100, 2501 E. Chapman Avenue, Fullerton, CA, 92831, US

(21) Appl. No.: 10/073,383

(22) Filed: Feb. 12, 2002

(51) Int. Cl. H02P 1/24; H02P 1/42; H02P 3/18; H02P 5/28; H02P 7/36

(52) U.S. Cl. 318/727

(57) ABSTRACT

The present invention resides in a capacitor-start, single-phase induction motor wherein connections for all coil windings are used during start-up and running of the motor. The induction motor during start-up is connected as a 2 pole motor and is switched to connect as a 4 pole motor when the capacitor drops out of the motor circuit. A cylindrical air gap motor with radial coils in a wound stator makes the pole change easily possible. The use of radial coils provides a design with a minimum of copper wire. This particular induction motor will reduce the use of copper wire in the wound coils by approximately 50%.

### BACKGROUND OF THE INVENTION

This invention resides in an improved capacitor start single-phase motor using less copper wire, wherein the motor starts as a 2 pole motor followed by the starting and running windings switching to a 4 pole connection when the capacitor drops out of the circuit. Utilizing a 4 pole double throw switch to start the motor, dynamic braking and rotation changes can be made by modifying the circuit. However, this will increase heating in the rotor. If a centrifugal switch is used during starting, a relay with 4 normally open and 4 normally closed contacts will be required. A design can be made so that during the switching, a change from parallel to series will provide more starting torque. The 2 pole start, 4 pole run single-phase motor may start and run as a 2 pole motor until the connections are switched to 4 pole.

### DESCRIPTION OF THE PRIOR ART

Single-phase motors are available in many different designs. In one of these designs, the capacitor-start induction motor has die-cast aluminum rotors and an auxiliary (starting phase) winding in series with a capacitor. During acceleration, a relay or a centrifugal switch disconnects this winding and a capacitor. These fractional and low horse power motors are suited to many constant speed applications, such as wash machines, machine tools, fans, blowers, mills, pumps, compressors, conveyors and others. Some of these motors are assembled directly with speed reducers or different accessory devices.

### SUMMARY OF THE INVENTION

The present invention resides in an improved single-phase motor using less wire in the wound stator assembly. Wherein 2 of the 4 poles wound for running are in series with a capacitor at start and all are connected as a 2 pole motor. When the capacitor is dropped out of the circuit, all poles are reconnected as a 4 pole motor. The motor may also continue to run as a 2 pole motor until the connections are switched to 4 pole. The connections of the coils may be changed from parallel to series for higher starting torque.

### BRIEF DESCRIPTION OF DRAWINGS

FIG. 1 shows stator connections in a capacitor-start single-phase motor.

FIG. 2 is a speed vs torque for a capacitor-start single-phase induction motor.

FIG. 3 is a speed vs torque for a 2 pole start to a 4 pole run capacitor-start single-phase induction motor of this invention.

FIG. 4 shows stator connections for a 2 pole start to a 4 pole run single-phase motor of this invention.

FIG. 5 is an end view of a stator assembly with a cross-section view of 4 coil windings.

### DETAIL DESCRIPTION OF THE INVENTION

This invention resides in a capacitor-start, single-phase induction motor using all windings during starting and running. Starting connected as a 2 pole motor, then connected as a 4 pole motor when the capacitor drops out of the circuit.

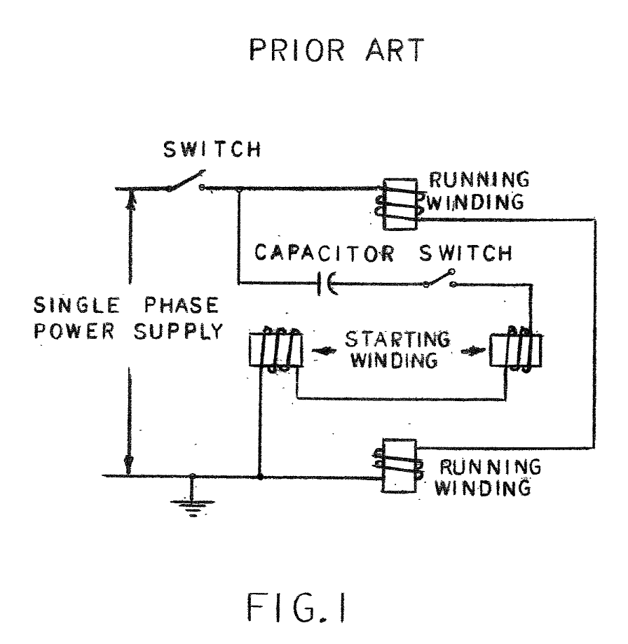

FIG. 1 Prior Art shows the stator connections in a capacitor-start single-phase induction motor. The switch by and in the capacitor circuit is closed when the switch by the power supply is closed to start the motor. When the motor reaches 70% of the running speed this switch opens and the capacitor no longer shifts the phase of the starting winding and this winding no longer adds power to the motor.

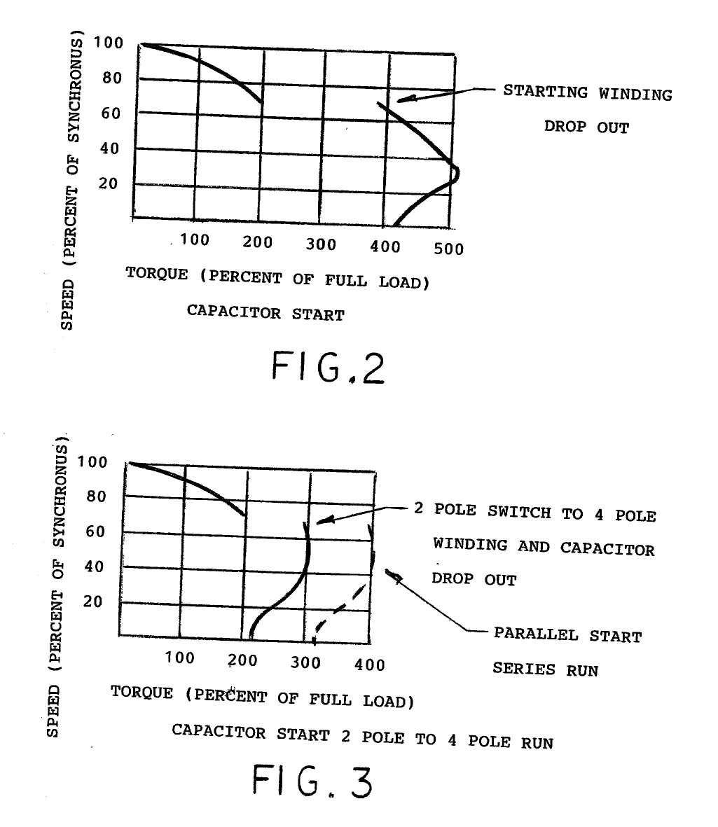

FIG. 2 is a speed vs torque curve of FIG. 1. It shows a loss of 50% when the starting winding drops out.

FIG. 3 is a speed vs torque of the invention showing a curve shape with starting torque a little better than a 3 phase induction motor.

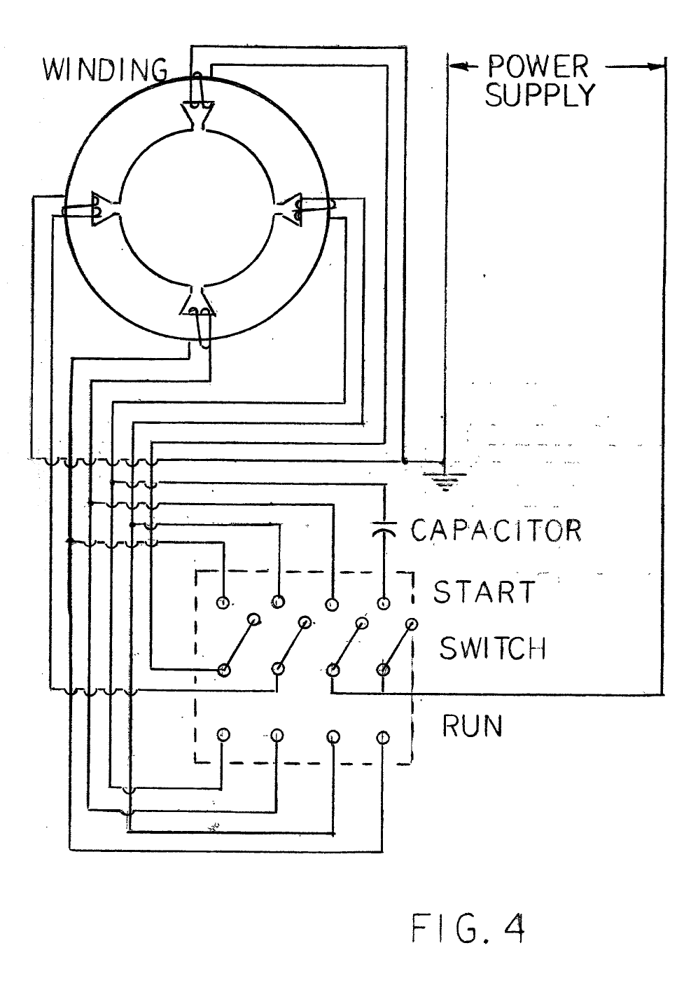

FIG. 4 shows stator connections for a 2 pole start to a 4 pole run single-phase capacitor start induction motor of this invention. A cylindrical air gap motor with radial windings makes the change easily possible. A single-phase power source, a capacitor and a 4 pole double throw switch is required. If the switch is not used, a relay with 4 normally open and 4 normally closed contacts will be required. The connections shown are for clockwise rotation as viewed. Counter-clockwise rotation requires changing two leads. If during starting, as the motor is brought up to speed, a switch opens in series with the capacitor, the motor will run at 2 pole speed until switched over to 4 pole.

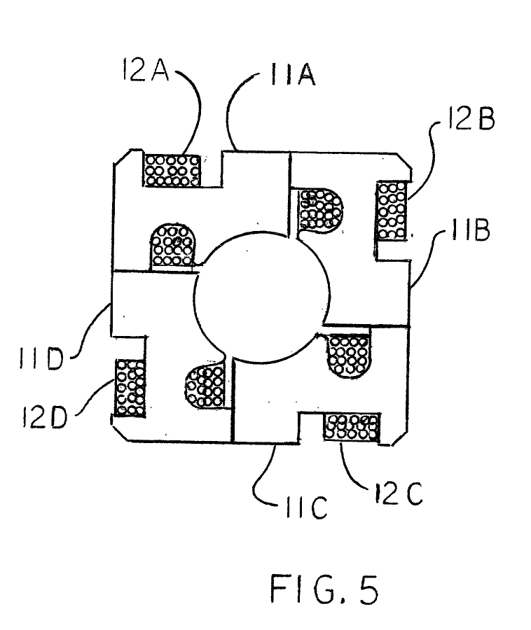

FIG. 5 is an end view of a stator assembly made up of 4 stator sub-sections 11A, 11B, 11C and 11D. Coil windings 12A, 12B, 12C and 12D are located in these stator sub-sections. These coils are effective like radial coils and facilitate winding. The mating location of the stator sub-sections can be made to permit using coil windings on spools.

1. A capacitor start single-phase induction motor having a circuit which comprises using winding coil connections utilizing all coil windings during starting of the motor as a 2 pole motor until reaching a change over speed, wherein the capacitor is removed from the circuit and winding coil connections change to a 4 pole motor for running using all coil windings.

2. The capacitor start single-phase induction motor described in claim 1, wherein a switch in series with the capacitor is opened on reaching change over speed, where the motor runs as at 2 pole speed, until all winding coil connections switch to run at 4 pole speed.

3. A capacitor start single-phase induction motor having a circuit which includes 2 winding coil connections in phase with a line current and 2 winding coil connections having an alternate phase produced by a capacitor at start rotation until a rotor reaches about 70% of full load speed, wherein the capacitor crops out of the circuit and all 4 winding coil connections switch in phase with a line current to a 4 pole motor connection.
